(19) United States
(12) Patent Application Publication
(10) Pub. No.: US 2011/0197577 A1
(43) Pub. Date: Aug. 18, 2011

(54) HYDRAULIC VIBRATION CANCELLING SYSTEM

(76) Inventor: Rodney Dale Hugelman, Orlando, FL (US)

(21) Appl. No.: 12/998,305

(22) PCT Filed: Oct. 6, 2009
(86) PCT No.: PCT/US2009/005479

§ 371 Date: Apr. 5, 2011

Related U.S. Application Data
(60) Provisional application No. 61/195,586, filed on Oct. 7, 2008.

(51) Int. Cl. F16D 31/02

(52) U.S. Cl. 60/416

(57) ABSTRACT

A pressure pulse cancelling device for use with hydraulic pumps/motors/transformers. There is a variable volume fluid receiving cylinder in fluid communication with the discharge line for receiving a quantity of fluid that equals the actual flow rate less the average flow rate in the pumping cycle. A piston or cam within the variable volume fluid receiving cylinder pumps the quantity of fluid received in the variable volume fluid receiving cylinder back into the discharge line when the actual flow rate is less than the average flow rate in the pumping cycle. A second variable volume fluid receiving cylinder is connected to the inlet line and receives a quantity of fluid that equals the actual flow rate less the average flow rate in the pumping cycle. A piston or cam within the second variable volume fluid receiving cylinder pumps the fluid received in the second cylinder into the inlet line at the proper time when the actual flow rate is less than the average flow rate in the inlet portion of the pumping cycle.

### I. CROSS REFERENCE TO RELATED APPLICATIONS

This application is based on and claims priority of U.S. provisional patent application 61/195,586 filed Oct. 7, 2008.

### II. FIELD OF THE INVENTION

This invention relates to hydraulic pumps, hydraulic motors and hydraulic transformers and a means to reduce vibration or pressure pulse on both the input and output lines of the pumps.

### III. BACKGROUND AND SUMMARY OF THE INVENTION

As the hydraulic industry and its users move to ever higher operating pressures the issue of vibration, noise, ripple, shock, surge and pressure pulse, hereinafter collectively referred to as “pressure pulse”, which are all related to the same cause, becomes more serious. The pressure pulses result in loud noise requiring the operator of the hydraulic equipment to wear ear protection. Furthermore, the pressure pulses cause the equipment connected to the hydraulics to severe stress and failure from the constant pressure pulses. At lower pressures the flexible elastic lines help dampen, but do not eliminate, hydraulic pulse at the cost of line fatigue. Very high hydraulic operating pressures require hard lines unable to dampen pressure fluctuations, thus passive accumulators and hydraulic mufflers are used to attenuate, but not eliminate, the source of these destructive pressure pulse waves. The source of this problem can be illustrated by considering a single cylinder hydraulic pump with its input flow as shown in FIG. 1. It must be remembered that a full cycle rotation is 360° while the input and output porting conduits, manifolds, or lines of each cylinder are active during only one-half of each cycle. Cylinder fill input flow rate plotted against time is graphically illustrated in FIG. 1. A cylinder input flow rate line 11 begins to flow at 0° immediately after top dead center, reaches a maximum fill rate at about mid stroke or 90° and then slows back down to a zero flow rate at 180° which is at bottom dead center (“BDC”). For the next one-half cycle the input line 11 is dormant at zero flow while the output line flow rate rises from zero, to maximum, and back again to zero. The input and output flow lines are sinusoidal. The cycle then repeats. An Average flow rate 13 is shown in FIG. 1. Clearly, the surge and stop stuttering can be expected to produce serious vibration on both the input lines and the output lines. The pump is in effect a hydraulic vibrator as well as the intended pump.

It should also be noted that the “average” flow rate 13, usually calculated, is based on the total bulk flow for one cycle and should not be confused with the dynamic actual flow rate behavior over time, as discussed above, and shown in FIG. 1. This cyclic surge is the source of hydraulic noise and vibration and a long term problem in the hydraulics industry.

One solution is to simply add more cylinders to provide overlap and reduce the surge of FIG. 1 to the ripple shown for the nine cylinder version illustrated in FIG. 2. The improved condition is clearly illustrated. The heavy intermittent surge is now reduced to hydraulic noise at the pressure pulse frequency. It should be kept in mind that this is not electrical noise or mechanical noise produced by the machine itself. This is hydraulic ripple noise generated at very high horsepower. Hydraulic pumps in the range of 50 kW are not uncommon and highlight the difference in scale between the electrical world and the mechanical world around us.

FIG. 3 illustrates a comparison between the hoped for smooth continuous “Average” flow rate 13 and the actual dynamic time line behavior for a two cylinder pump. At the start of the input flow rate is zero but soon builds to the average value and then overshoots the mean value before dropping back down to zero where the second cylinder comes on line to repeat the process. A solution presents itself. By providing a variable volume pocket synchronized to the pump cycle, an over flow volume 15 could be synchronously absorbed and then re-delivered as an under flow volume 17 during the under flow period thus maintaining a continuous mean flow rate from the input line. This same feature would be used on the output cycle and produce a continuous mean flow rate on the output line. This results in greatly reduced or completely eliminated pressure pulse and vibration.

The inventive device can be expected to be scalable as illustrated in FIG. 3. An important point is that the input/output cycles are sinusoidal and therefore mirror images of each other which simplifies the actual mechanism and its deployment on the pump.

Another example with a three cylinder pump is illustrated in FIG. 4. It is seen that the pressure pulse volumes are now much smaller. Thus, the mechanism and the synchronized variable volume becomes smaller with each additional cylinder while still erasing the pressure pulse.

The foregoing process and mechanism is not a passive “filter” such as an accumulator or hydraulic muffler would be. Rather, it is an active pressure pulse cancelling system analogous to active noise cancelling microphones, head sets, etc. FIG. 5 shows an inventive, multi-circuit pump/motor/transformer whereby separate circuits may be manifolded portions of the total number of pistons and cylinders. One ripple compensator is supplied for each circuit. As illustrated a stack of three compensators (or more) may be attached to the device, depending upon the user's configuration of cylinders and circuits.

The inventive device can also be configured for use by other hydraulic pumps which only have a single circuit, and the device may be an integral part of the pump or motor itself.

### IV. BRIEF DESCRIPTION OF THE DRAWINGS

FIG. 1 is a graph of the flow rate of a single cylinder hydraulic pump.

FIG. 2 is a graph of the flow rate a nine cylinder hydraulic pump.

FIG. 3 is a graph illustrating the comparison of the actual dynamic flow rate to the desired flow rate and illustrates the desired goal of providing a variable volume pocket synchronized to the pump with the overflow volume absorbed by the under flow time period.

FIG. 4 is a graph similar to FIG. 3 except utilizing three cylinders rather than two cylinders.

FIG. 5 is a cross section view of the inventive pump/motor/transformer and the pressure pulse compensators used to cancel the pressure pulse developed by the pump/motor/transformer.

FIG. 6 is a cross sectional side view of the alternative fluid receiving cylinder in which the cylinder is rectangular in shape and the cam is used to vary the volume of the cylinder.

FIG. 7 is an end view of the alternative fluid receiving cylinder and cam of FIG. 6.

### V. DESCRIPTION OF THE PREFERRED EMBODIMENT

A high pressure hydraulic pump/motor/transformer (collectively referred to herein as a “pump”) suffers from the problem of undesirable pressure pulses. The instant invention substantially eliminates the pressure pulses by means of providing a variable volume pocket synchronized with the pump cycle, with the variable volume synchronously absorbed and re-delivered during the flow cycle. The invention is an active pressure pulse cancelling system, unlike passive systems.

The vibration cancelling system and pump is illustrated in FIG. 5. There is a multi-cylinder axial pump 10. A drive shaft 12 spins a cylinder barrel 14 containing a plurality of cylinders 16. Each cylinder has a piston 18 that has inlet and outlet ports. The shaft has opposite ends 20, 22 with the input or driving end 20 being at one end and the output or driven end 22 extending from pump 10 at the end opposite the input end. There is wedge 24 that causes the pistons 18 to reciprocate as the cylinder barrel 14 spins. The drive shaft 12 has one end connected to the cylinder barrel 14 with the other end connected to a rotative power source, causing the cylinder barrel 14 to rotate with respect to the wedge 24, which in turn drives the pistons 18 up and down within their respective cylinders. This is representative of conventional axial machines and pumps found in use today.

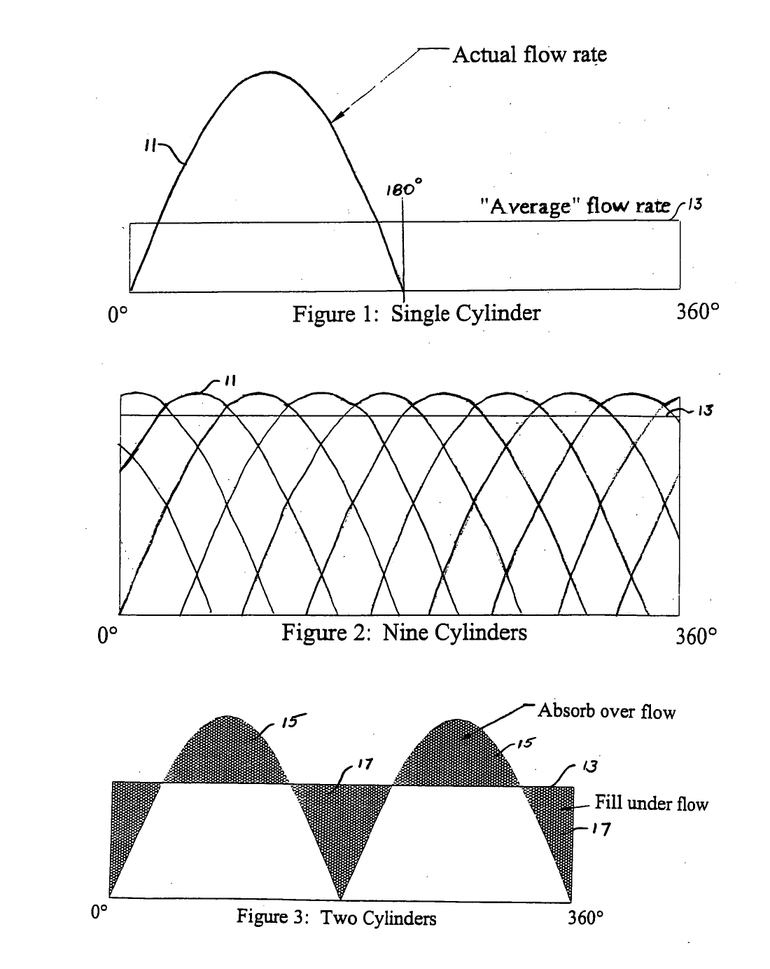

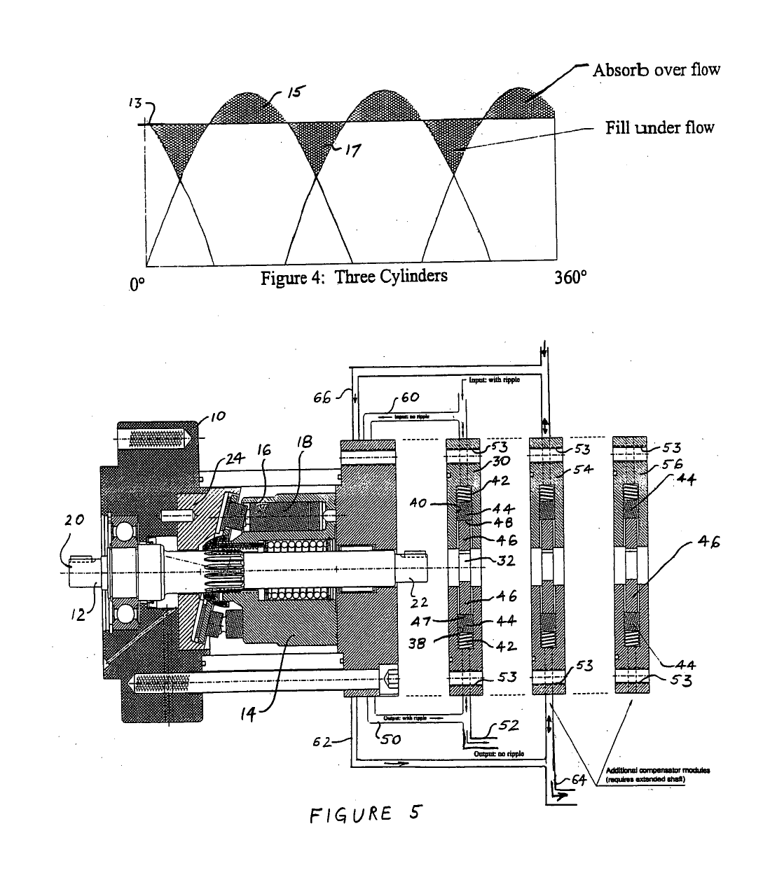

In one embodiment there are nine cylinders in the cylinder barrel. The cylinders can have their inputs connected together and their outputs connected together to form one or more circuits. Depending on the number of cylinders, various arrangements of circuits may be created. For example, the simplest example is to have a single cylinder hydraulic pump. This is more fully described when reviewing FIG. 1 and described in the Background and Summary of the Invention. In another embodiment, there can be three cylinders that are interconnected to create a three cylinder circuit such as illustrated in FIG. 4. In yet another example there can be nine cylinders with three cylinders that are interconnected to create each circuit resulting in three separate three cylinder independent circuits.

In the simple embodiment of just one circuit, all the inputs to the cylinders are connected together and the outputs are connected together. A pressure pulse compensator 30 is connected to the driven end 22 of the shaft 12. In the embodiment illustrated the compensator 30 has a central shaft keyway pocket or bore 32 in a lobed cam 46 that is connected with the driven end 22 of the shaft 12 of pump 10. In another embodiment the lobed cam 46 incorporates its own integral shaft to be connected with a conventional coupling to driving end 22 of pump 10. In either case, the intent is to provide rotational power to the central axis of the compensator 30 as will be described herein. There are passageways 53 in the opposite ends of the compensator through which fastening bolts (not illustrated) can be passed to attach the compensator to the housing of the pump 10.

In the first embodiment, cylinders 38, 40 are radially disposed about the central shaft keyway bore 32 and lobed cam 46. Inside each of the cylinders 38 and 40 is a spring 42 that pushes against piston 44. The piston 44 is pushed against the cam 46 that is made rotationally operable by the shaft 22 of pump 10. As the shaft 22 rotates, it causes the lobed cam 46 to rotate. The cam 46 has a cam surface lobe profile that drives the piston 44 within its respective cylinder 38 or 40. The cylinder 38 is fluidly connected to an output 50 from the pump 10. In a high pressure pump, the pump output 50 normally has a pressure pulse as previously described. This is the problem that the inventive device solves, which is how to provide an output having little or no pressure pulse in high pressure pumps. The shaft 12 synchronously rotates the cam 46 so that a lobe 47 of the cam 46 drives the piston 44 to discharge a matching volume of fluid into the pump output 50 volumetrically compensating exactly to match the output pressure pulse or surge. The result is that a combined output from the pump 10 and the compensator 30 shown at 52 has little or no pressure pulse or ripple.

The shape of the cam 46 is very important. The cam shape must have a cam lobe profile contour allowing a synchronous movement of piston 44 changing the volume of cylinder 38 to match the actual flow rate of the input line 11 as it passes below the average flow rate line 13 as illustrated in FIG. 3. This cam lobe profile shape allows the under flow volume 17 to be discharged into the pump output 50 at the proper time and in the proper amount. The cam shape adjusts the cylinder cavity volume to match the profile of the under flow volume in order to accomplish this. It can be seen in FIG. 3 that the shape of the under flow volume 17 is different than the shape of the over flow volume 15, necessitating a different cam lobe surface profile than one that would generate as a sinusoidal curve. The cam surface profile must include a combination of profile 15 and profile 17 to accommodate the changing flow rate of the piston as it accelerates, decelerates and changes direction during its cycle.

Similar to the connection of the cylinder 38 to the pump output 50, the cylinder 40 is fluidly connected to a pump input 60. The pump input 60 normally has a pressure pulse or surge associated with the input of the pump 10. Both input and output surge patterns are near mirror images. Therefore, the cam 46 employs another cam profile 48 that drives the piston 44 in the cylinder 40. This discharges a matching volume of fluid into the pump input 60 to compensate for the intake pressure pulse. As previously described, the cam profile 48 of the cam 46 must provide for the proper timing and amount of under flow volume to be discharged into the pump input 60. The result is that the combined intake into the pump 10 has no or very little pressure pulse or surge.

In the second embodiment where there is an integral central shaft connected with the driven end 22 of pump 10 and thereby provides the rotative power to drive the cam 46 in the manner described in the first embodiment. The operation of the compensator 30 is the same.

It should be noted that the amount of fluid delivered from the piston 44 during the discharge portion of its stroke is equal to the amount of fluid that the piston 44 receives during the intake portion of its stroke. Thus the amount of fluid taken in is equal to the amount discharged. This is illustrated graphically in FIGS. 3 and 4 as the over flow volume 15 is the same as the under flow volume 17. Further, in this embodiment only a single inlet/outlet compensator pair of pistons is necessary for each flow circuit regardless of the plurality of pistons fluidly connected to that circuit. The compensator cam will include the same number of cam lobe profiles as there are cylinders.

The compensator 30 has a predetermined volume of fluid that it discharges to compensate for the amount of pressure pulse over/under flow introduced into the input or output of the pump 10. Also, the number of compensators 30 will depend on the number of individual circuits of a given pump arrangement. For example three circuits will require three compensators. All of the compensators should be connected to the same common drive shaft 12 so that the cam lobe profiles can be synchronized with their respective cylinders 16 and pistons 18 in the pump 10. FIG. 4 illustrates the output flow when connecting three compensators 30, 54 and 56 to the drive shaft 12. As seen in FIG. 5, the compensators 30, 54 and 54 can be stacked one on top of the other and fastened together and to the housing of the pump 10 by means of fastening bolts. When multiple compensators are used, an extended shaft 12 must be used so that the shaft 12 will extend through all of the compensators. When there are two circuits, two compensators are used. As illustrated in FIG. 5, compensators 30 and 54 are attached to the pump 10. The compensator 54 is connected to a second output 62 that connects the second circuit from the pump 10 to the compensator 54. A combined output 64 from the second circuit will be substantially free of pressure pulses. Similarly the second circuit input 66 is connected to the compensator 54 so that the combined input from the compensator and the input line will be substantially free from pressure pulses. The compensator 54 operates in the same manner as the compensator 30.

When multiple cylinders and pistons are used in the pump, the user has the flexibility of combining the inputs and outputs to create varying circuits. For example, as previously stated, when there are nine cylinders, one arrangement can have three independent circuits, each with three cylinders interconnected. This system requires three compensators to be connected to the drive shaft 12. In this configuration when using pistons to create the variable cavity or cylinder, each compensator has a cam with three lobes each lobe containing the input/output cam profile. This results in nine lobes, one for each cylinder. If we assume there are a five cylinder circuit and an independent four cylinder circuit, then two compensators are needed, one with a cam having five lobes and the other cam having four lobes. Again we see that the number of lobes equals the number of cylinders.

In each example we must compensate for the pressure pulse generated by the pistons in the high pressure pump. Each circuit has a corresponding “pressure pulse volume” generated by the pistons. The corresponding compensator with its cam must generate a matching volume with the cam timed to synchronize with the input/output pressure pulse flow profile. The cam profile must synchronize with the over flow/under flow illustrated in the graphs illustrated in FIGS. 3 and 4 of a given pump configuration.

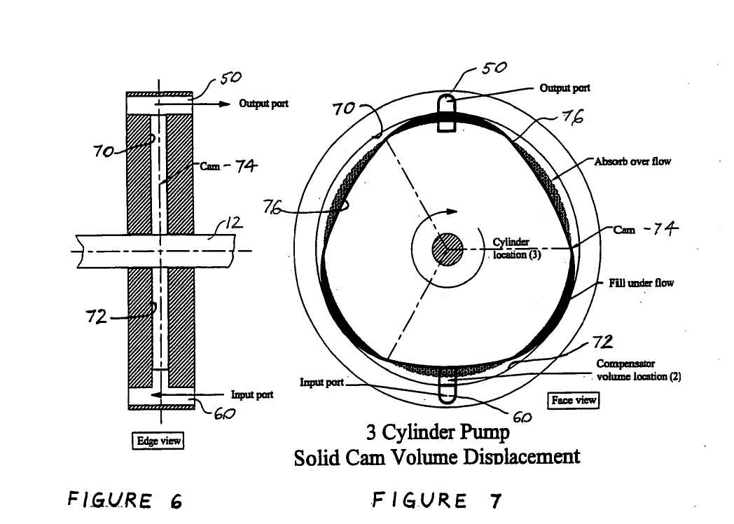

A further compensator embodiment is illustrated in FIGS. 6 and 7. In this embodiment, a variable volume cavity or variable volume cylinder 70, 72, has the volume varied without using pistons. Instead, the configured shape of a cam 74 is utilized to increase/decrease the available volume of the compensator cavity as it passes through the cylinder cavity 70 and 72. The cam 74 is mounted on and driven by the drive shaft 12 as previously described. As the synchronized variable volume cam 74 with its contoured shape enters and passes through the cylinder cavity 70 and 72, the available cavity fluid volume would be altered to precisely compensate for the over/under flow rate. This embodiment would not use the previous compensator piston assembly, but use the shape of the cam to variably alter the volume of cylinder cavities 70 and 72 through its rotational sweep. In this embodiment, the geometry of the cylinder is modified to accommodate the cam 74. In this alternative configuration the cylinder cavities 70 and 72 are rectangular pockets as illustrated in FIGS. 6 and 7 with the cam 74 mounted on the drive shaft 12. The cam 74 is a fixed width design. Another cam configuration is the have the cam with a fixed radius and a variable thickness at the outer edge or rim to achieve the change in the volume cavity. An advantage of using the cam 74 as the means to vary the cylinder or cavity volume is that the cam 74 can more rapidly respond to changes to the actual flow rates. This is because the springs and piston have a mass and inertia that must be overcome to compensate for the fluid flows. A cam can have its surface profile accommodate very rapid and extreme changes in flow rate that is not hindered by the mechanical inertia of the piston and cam system.

It can also be observed that the higher the number of pistons and cylinders in a circuit, the lower the pressure pulse surge flow volumes. Therefore, the smaller will be the displacement of the compensator volume.

Thus there has been provided a compensator for cancelling noise in high pressure hydraulic pumps. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. In a hydraulic pump having at least one piston that reciprocates during a pumping cycle and delivers fluid to a pump discharge line at an average fluid flow rate during the pumping cycle, the piston driven by means of a drive shaft, the piston delivering fluid to the discharge line at an actual flow rate greater than the average flow rate during a portion of the pumping cycle and not delivering fluid to the discharge line during another portion of the pumping cycle, a pressure pulse cancelling device for use with the hydraulic pump comprising:
a variable volume fluid receiving cylinder in fluid communication with the discharge line for receiving a quantity of fluid that equals the actual flow rate less the average flow rate in the pumping cycle, and
first variable means within the variable volume fluid receiving cylinder for pumping the quantity of fluid received in the variable volume fluid receiving cylinder back into the discharge line when the actual flow rate is less than the average flow rate in the pumping cycle.

2. The device of claim 1 wherein the first variable means within the variable volume fluid receiving cylinder for pumping the quantity of fluid received in the variable volume fluid receiving cylinder back into the discharge line comprises first compensator first piston means operatively connected to the drive shaft.

3. The device of claim 1 wherein the first variable means within the variable volume fluid receiving cylinder for pumping the quantity of fluid received in the variable volume fluid receiving cylinder back into the discharge line comprises first compensator first cam means operatively connected to the drive shaft.

4. The device of claim 1 wherein the hydraulic pump receives fluid through a pump inlet line at a second average fluid flow rate during the pumping cycle, the piston receiving fluid from the inlet line at a second actual flow rate greater than the average flow rate during a second portion of the pumping cycle and not receiving fluid from the inlet line during another second portion of the pumping cycle, a second pressure pulse cancelling device comprising:
a second variable volume fluid receiving cylinder in fluid communication with the inlet line for receiving a second quantity of fluid that equals the second actual flow rate less the second average flow rate in the pumping cycle, and
second variable means within the second variable volume fluid receiving cylinder for pumping the second quantity of fluid received in the second variable volume fluid receiving cylinder back into the inlet line when the second actual flow rate is less than the second average flow rate in the pumping cycle.

5. The device of claim 4 wherein the second variable means within the second variable volume fluid receiving cylinder for pumping the quantity of fluid received in the second variable volume fluid receiving cylinder back into the inlet line comprises first compensator second piston means operatively connected to the drive shaft.

6. The device of claim 4 wherein the second variable means within the second variable volume fluid receiving cylinder for pumping the quantity of fluid received in the second variable volume fluid receiving cylinder back into the discharge line comprises first compensator second cam means operatively connected to the drive shaft.

7. The device of claim 6 wherein the second cam means draws from the discharge line the second quantity of fluid received in the second variable volume fluid receiving cylinder.

8. The device of claim 2 and further comprising piston driving cam means operatively connected to the first compensator first piston means for driving the first compensator first piston means to pump the quantity of fluid received in the cylinder back into the discharge line when the actual flow rate is less than the average flow rate in the pumping cycle.

9. The device of claim 8 wherein the piston driving cam means has a cam profile that allows the first compensator first piston means to move in the cylinder to draw from the discharge line the quantity of fluid that equals the actual flow rate less the average flow rate in the pumping cycle.

10. The device of claim 5 and further comprising second piston driving cam means operatively connected to the first compensator second piston means for driving the first compensator second piston means to pump the quantity of fluid received in the second variable volume cylinder back into the inlet line when the second actual flow rate is less than the second average flow rate in the pumping cycle.

11. The device of claim 10 wherein the second piston cam means has a second cam profile that allows the first compensator second piston means to move in the second cylinder to draw from the inlet line the quantity of fluid that equals the second actual flow rate less the second average flow rate in the pumping cycle.

12. The device of claim 1 and further comprising a second fluid circuit having at least a second piston in the pump that reciprocates during the pumping cycle and delivers fluid to a second discharge line at a third average fluid flow rate during the pumping cycle, the second piston driven by means of the drive shaft, the second piston delivering fluid to the second discharge line at a third actual flow rate greater than the third average flow rate during a portion of the pumping cycle and not delivering fluid to the second discharge line during another portion of the pumping cycle, a third pressure pulse cancelling device for use with the hydraulic pump comprising,
a third variable volume fluid receiving cylinder in fluid communication with the second discharge line for receiving a second quantity of fluid that equals the third actual flow rate less the third average flow rate in the pumping cycle, and
third variable volume means within the third variable volume fluid receiving cylinder for pumping the third quantity of fluid received in the third variable volume fluid receiving cylinder back into the second discharge line when the third actual flow rate is less than the third average flow rate in the pumping cycle.

13. The device of claim 12 wherein the third variable means within the third variable volume fluid receiving cylinder for pumping the quantity of fluid received in the third variable volume fluid receiving cylinder back into the second discharge line comprises second compensator first piston means operatively connected to the drive shaft.

14. The device of claim 12 wherein the third variable means within the third variable volume fluid receiving cylinder for pumping the quantity of fluid received in the third variable volume fluid receiving cylinder back into the second discharge line comprises second compensator first cam means operatively connected to the drive shaft.

15. The device of claim 12 wherein the second fluid circuit receives fluid through a second inlet line at a fourth average fluid flow rate during the pumping cycle, the second piston receiving fluid from the second inlet line at a fourth actual flow rate greater than the fourth average flow rate during a second portion of the pumping cycle and not receiving fluid from the second inlet line during another second portion of the pumping cycle, a fourth pressure pulse cancelling device comprising:
a fourth variable volume fluid receiving cylinder in fluid communication with the second inlet line for receiving a fourth quantity of fluid that equals the fourth actual flow rate less the fourth average flow rate in the pumping cycle, and
fourth variable means within the fourth variable volume fluid receiving cylinder for pumping the fourth quantity of fluid received in the fourth variable volume cylinder back into the second inlet line when the fourth actual flow rate is less than the fourth average flow rate in the pumping cycle.

16. The device of claim 13 and further comprising second compensator cam means operatively connected to the second compensator first piston means for driving the second compensator first piston means to pump the quantity of fluid received in the third variable volume fluid receiving cylinder back into the second discharge line when the third actual flow rate is less than the third average flow rate in the pumping cycle.
